(19) United States
(12) Patent Application Publication
(10) Pub. No.: US 2010/0205781 A1
(43) Pub. Date: Aug. 19, 2010

(54) HANDGRIP PIVOT STRUCTURE OF HAND PULLER

(76) Inventor: Wen-Cheng Zhang, Changhua City (TW)

Correspondence Address: LEONG C LEI, PMB # 1008, 1867 YGNACIO VALLEY ROAD, WALNUT CREEK, CA, 94598, US

(21) Appl. No.: 12/370,612

(22) Filed: Feb. 13, 2009

(51) Int. Cl. B25G 1/00

(52) U.S. Cl. 16/421

(57) ABSTRACT

A handgrip pivot structure is provided for a hand puller, including two spaced anus defining aligned holes, a shaft rotatably arranged between the arms, and a collar rotatably fit over the shat for being hand held by an operator to reciprocally sway the hand puller and thus tighten or loosen a cable. The present invention provide such a feature that two pivoting arrangements are provided respectively between the shaft and the collar and between the shaft and the holes of the arms, whereby 360 degree full-turn rotation of the handgrip can be realized with more smooth operation than the conventional structure and jamming and stress concentration can be effectively eliminated.

### TECHNICAL FIELD OF THE INVENTION

The present invention generally relates to a handgrip pivot structure for a hand puller, and particularly to a handgrip pivot structure that makes rotation of handgrip smooth and eliminates jamming and stress concentration.

### DESCRIPTION OF THE PRIOR ART

Cargo vehicles carry cargos that are often secured on a bed by cables or wires. An end of the cable is fixed first and a pre-set tightening force is applied to an opposite end to secure the opposite end. This operation must be carried out elaborately and skilled operators are needed to ensure proper tightening of cargos on the vehicle bed.

Taiwan Utility Model Publication Nos. M320549, M319128, M313048, and M261501 and Invention Publication Nos. 567961, 512809, and 383756 disclose various hand pullers for carrying out tightening of cables. The known hand puller comprises a fixed frame and a movable frame that are jointed through a pivot shaft, which is often of a semi-circular configuration, for effecting reciprocal swaying operation within a given angular range to drive a one-way ratcheting mechanism. The fixed frame has a stop that provides positioning to the ratcheting mechanism so that the cable can be rolled up by the pivot shaft to have the cable tightened and thus securing the cargos.

Referring to FIGS. 1 and 2 of the attached drawings, the movable frame 90, or the fixed frame, comprises two opposite and spaced arms 91 that have free ends forming aligned pivot holes 92 for mounting a handgrip 80. The handgrip 80 comprises a metal shaft 81 that has an outer circumference around which a flexible plastic sleeve 82 is fit. Opposite ends of the shaft 81 extend beyond the sleeve 82 and are respectively and rotatably received in the pivot holes 92 to position the sleeve 82 between the arms 91, whereby when an operator holds the sleeve 91 with one hand and reciprocally sways the aims by rotating the sleeve 82 about a central axis, the shaft 81 is caused to rotate in the pivot holes 92, which effectively reduces the relative motion and abrasion caused between the operator's hand and the sleeve 82.

The conventional structure is operated by causing rotation between the shaft 81 and the pivot holes 92 only to prevent the sleeve 82 from rotation with respect to the operator's hand during the operation of the hand puller. However, the contact area between the shaft 81 and the pivot holes 82 is very limited, which may lead severe stress concentration during the rotation of the shaft 81. Consequently, severe wear occurs between the shaft 81 and the pivot holes 92, which may eventually results in jamming or unsmooth operation. Thus, it is desired to overcome such drawbacks by providing a handgrip pivot structure for a hand puller that will further described hereinafter.

### SUMMARY OF THE INVENTION

The present invention provides a handgrip pivot structure for a hand puller, which comprises a grip collar that is rotatably fit over a shaft arranged between two spaced arms, so as to form two pivoting arrangements respectively between the collar and the shaft and between the shaft and pivot holes defined in the arms, whereby 360 degree turn of the collar can be realized, making the turning smoother than the conventional structure and providing extended service life, and also helpful in overcoming jamming and stress concentration problems of the conventional structure.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a conventional handgrip of a hand puller.

FIG. 2 is a cross-sectional view of the conventional handgrip of the hand puller.

FIG. 3 is an exploded view of a hand puller in which a handgrip pivot structure in accordance with the present invention is embodied.

FIG. 4 is a perspective view of the hand puller of the present invention with the handgrip detached.

FIG. 5 is a perspective view of the hand puller of the present invention.

FIG. 6 is a cross-sectional view of the handgrip of the hand puller of the present invention.

FIG. 7 is a cross-sectional view illustrating a handgrip constructed in accordance with a second embodiment of the present invention.

FIG. 8 is a cross-sectional view illustrating a handgrip constructed in accordance with a third embodiment of the present invention.

FIG. 9 is a cross-sectional view illustrating a handgrip constructed in accordance with a fourth embodiment of the present invention.

FIG. 10 is a cross-sectional view illustrating a handgrip constructed in accordance with a fifth embodiment of the present invention.

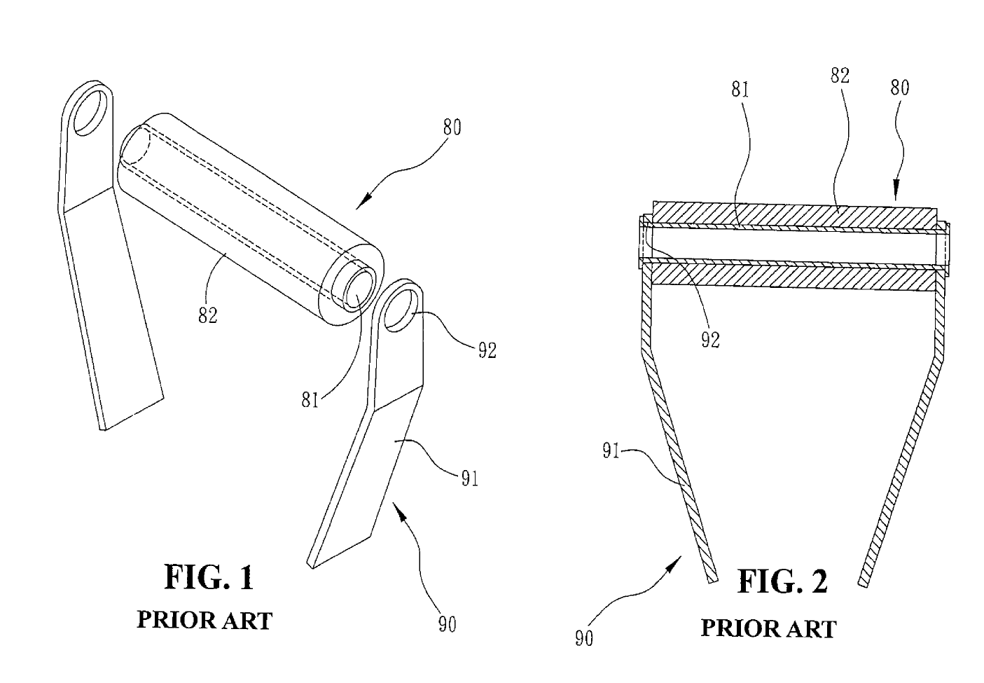

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

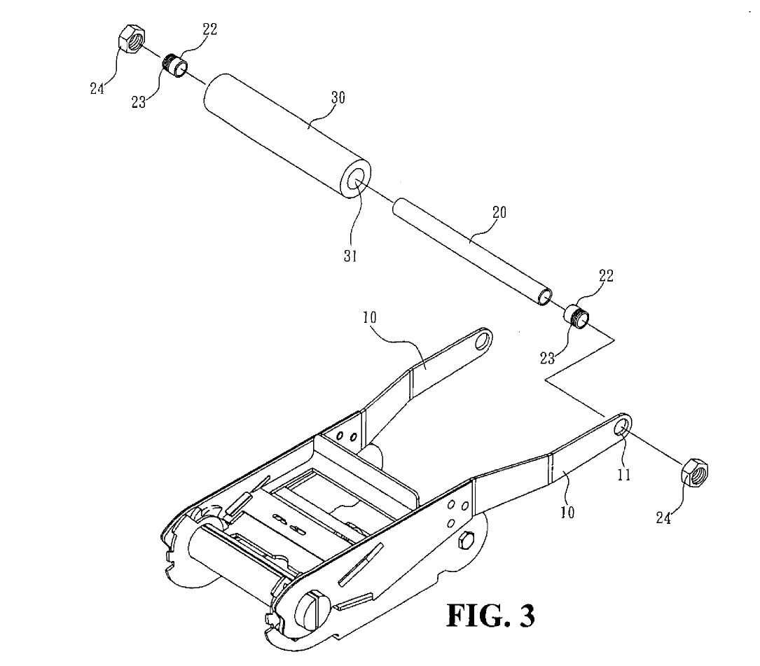

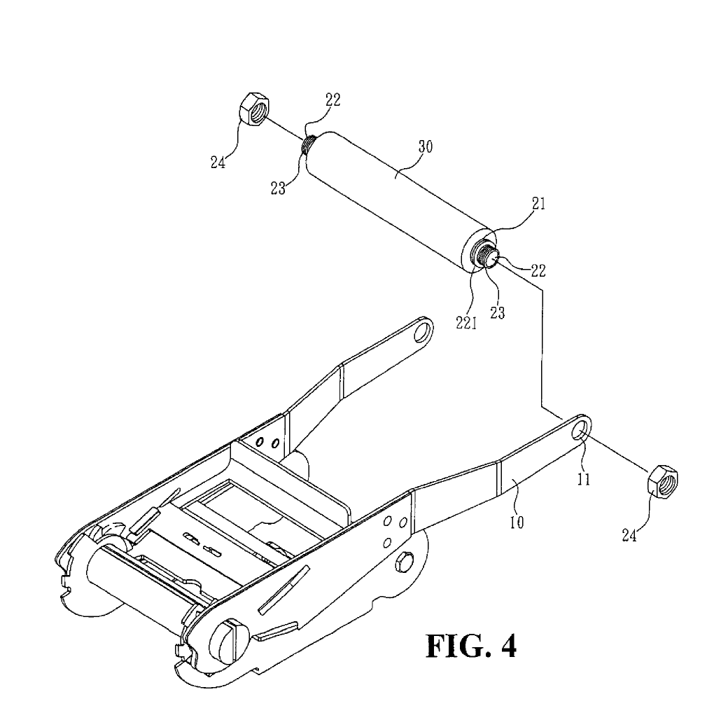

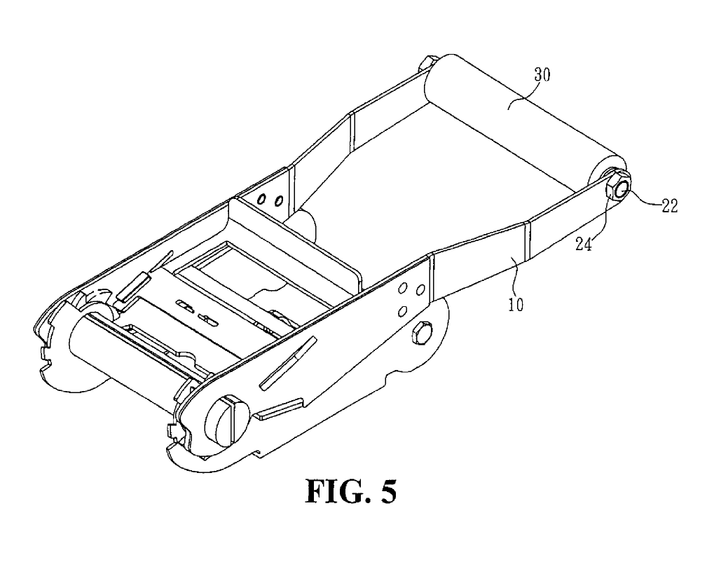

With reference to FIGS. 3-6, a hand puller constructed in accordance with the present invention comprises two arms 10 mounted to a moving frame or a fixed frame of the hand puller. The arms 10 are set to be opposite to and spaced from each other, preferably in a symmetric manner. Align pivot holes 11 are defined in distal free ends of the arms.

A handgrip comprises a metal shaft 20 and a grip collar 30 that is preferably made of plastics, such as a rigid plastic tube rotatably fit over the shaft 20. The shaft 20 has opposite ends that are expanded to form a circumferential flange 21 to which a mounting tube 22 is attached in a co-axial manner. The mounting tubes 22 that are respectively attached to the end flanges 21 of the shaft 20 extend through and are rotatably received in the pivot holes 11 of the arms 10 respectively. Each mounting tube 22 has an end forming an expanded circumferential flange 221 that is fixed to the shaft 20 at the respective circumferential flange 21 of the shaft 20 by means of for example welding or other known measures, whereby the shaft 20 is held between the two arms 10 without undesired separation therefrom. Further, each mounting tube 22 has an opposite end extending beyond an outside surface of the respective arm 10 and the portion of the mounting tube 22 that extends beyond the arm 10 forms external threading 23 for threading engagement with a nut 24. The nut 24 has an outside diameter that is greater than the pivot hole 11, whereby the shaft 20 is prevented from separation from the pivot holes 11 by the two nuts 24. The grip collar 30 is for hand gripping by an operator. The grip collar 30 defines a bore 31 completely extending therethrough in an axial direction for axially and rotatably receiving therein the shaft 20 to hold the grip collar 30 between the two arms 10.

The present invention provides a configuration that comprises a first pivoting arrangement constituted by the rotatable fitting of the collar 30 over the shaft 20 and a second pivoting arrangement between the shaft 20 and the pivot holes 11, whereby when an operator holds the grip collar 30 with a hand and reciprocally sways the arms 10 of the hand puller to gradually tighten or loosen a rope or a cable, the grip collar 30 maintains rotation of full turns around the shaft 20, while the shaft 20 is also rotatable with respect to the pivot holes 11, whereby the rotation of the grip collar 30 with respect to the arms 10 can be made smooth as compared to the known structures. Further, the two pivoting arrangements in accordance with the present invention effectively disperse the force acting on any single one thereof so as to extend the service life thereof and also alleviate the problem of jamming occurring in the conventional structures.

Referring to FIG. 7, a second embodiment of the present invention is shown, wherein the grip collar 30 has an outer circumferential surface that forms spaced gripping troughs 32 that provide an increased contact surface between the operator's palm and the collar. Further, the grip collar 30 may be of any geometric shape as desired.

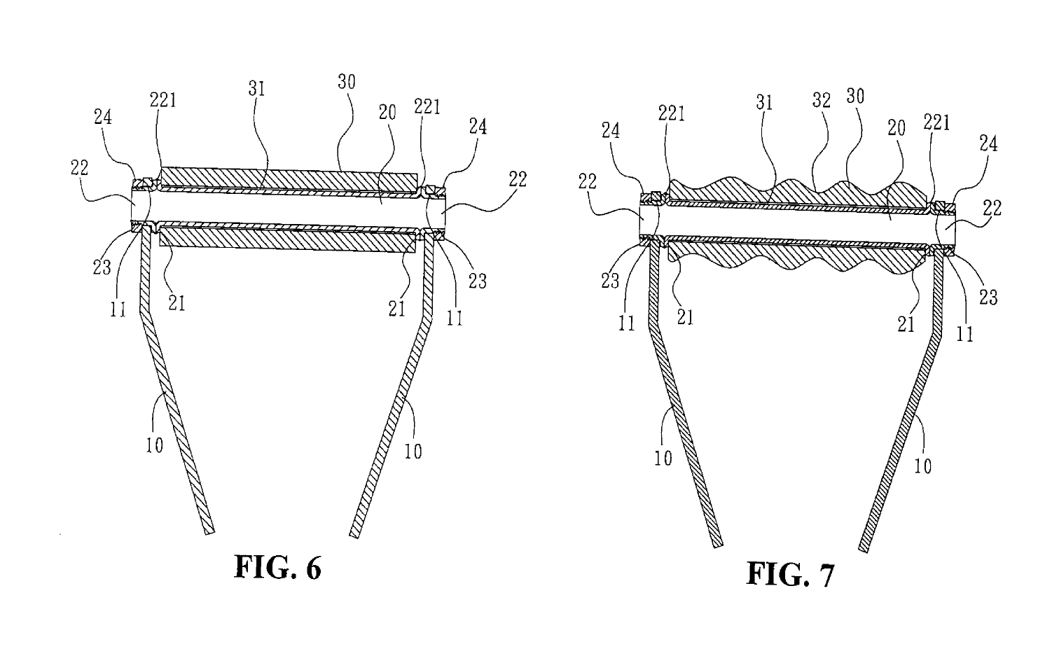

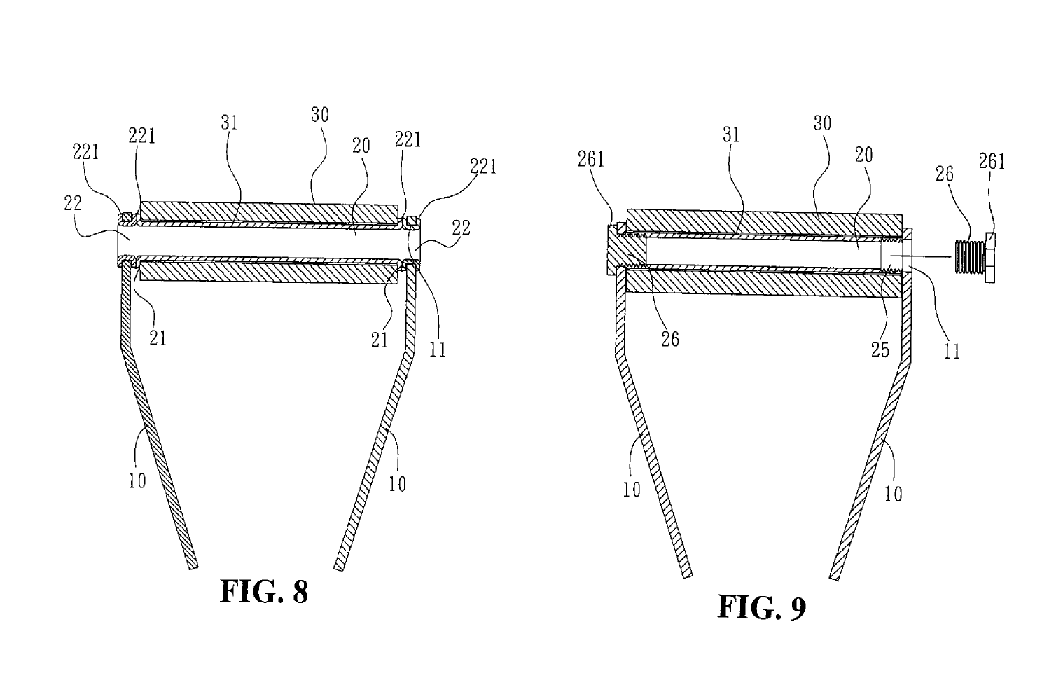

Referring to FIG. 8, a third embodiment of the present invention is shown, wherein the two mounting tubes 22 are rotatably received in the respective pivot holes 11 and an outer end of each mounting tube 22 forms an expanded circumferential flange 221 that has an outside diameter greater than that of the respective pivot hole 11, whereby the mounting tube 22 is securely and rotatably held in the pivot hole 11 without undesired separation. The shaft 20 is, similar to what described above, welded to and set between the inner end flanges 221 of the mounting tubes 22. This provides a structure functioning similar to or equivalent to the combination of external threading 23 and the nut 24 shown in FIG. 6.

Referring to FIG. 9, a fourth embodiment of the present invention is shown, wherein the shaft 20 has opposite ends each forming an internally threaded bore 25. A bolt 26 is set outside each arm 10 and has a threaded section extending through the pivot hole 11 of the arm 10 to threadingly engage the internally threaded bore 25 with an expanded head 261 of the bolt 26 serving as a stop that abuts against an outside surface of the respective arm 10 to prevent the shaft 20 from separation from the pivot hole 11. The arrangement of the internally threaded bore 25 and the bolt 26 provides a similar or equivalent function to the combination of external threading 23 and the nut 24 shown in FIG. 6.

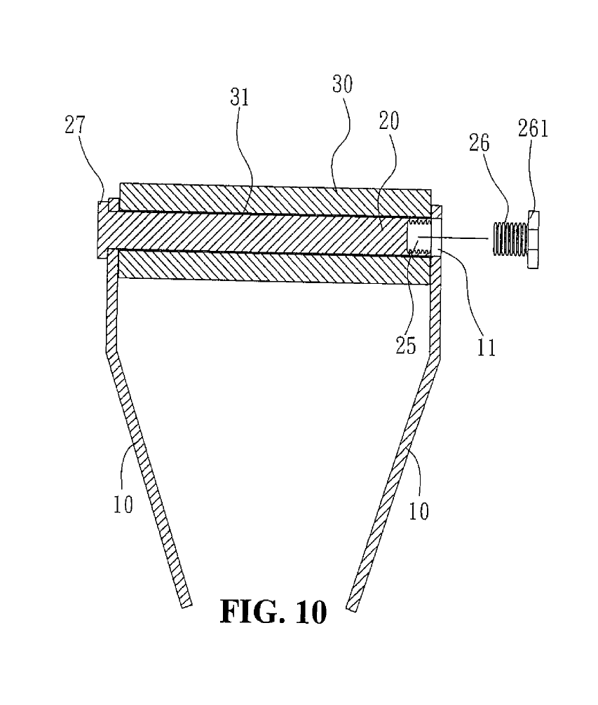

Referring to FIG. 10, a fifth embodiment of the present invention is shown, wherein the shaft 20 has an end forming an expanded flange 27 and an opposite end forming an internally threaded bore 25. The shaft 20 is fit into and received in the pivot hole 11 of one of the anus 10 of the hand puller with the expanded flange 27 located outside and abutting against an outside surface of the arm 10. A bolt 26 is set outside the other arm 10 of the hand puller with a threaded section extending through the pivot hole 11 of said other arm 10 to threadingly engage the internally threaded bore 25 of the shaft 20, an expanded head 261 abutting against the outside surface of said other arm 10, whereby the shaft 20 is prevented from separation from the pivot holes 11, and an equivalent result as that of the arrangement of external threading 23 and nut 24 shown in FIG. 6 can be obtained.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A handgrip pivot structure for a hand puller, comprising:
two arms, which are opposite to and spaced from each other and have free ends that define aligned pivot holes; and
a handgrip, which comprises a shaft and a collar rotatably fit over the shaft, the shaft being rotatably arranged between the arms and having opposite ends each corresponding to the arms respectively and each forming an expanded end flange to which a mounting tube is coaxially mounted, the mounting tube being rotatably received in the respective pivot hole, the mounting tube having an end forming an expanded flange fixed to the end flange to prevent the shaft from separation from the arms, each mounting tube having an end extending beyond the pivot hole and forming an external thread outside the arm to engage a nut for securing the mounting tube in the pivot hole of the aim, the collar being for hand gripping by an operator and defining a bore extending completely therethrough for rotatably receiving the shaft therein so as to set the collar between the arms, wherein a first pivoting arrangement is presented between the collar and the shaft and a second pivoting arrangement is presented between the shaft and the pivot holes of the arms.

2. The handgrip pivot structure according to claim 1, wherein the collar has an outer circumferential surface that forms spaced gripping troughs.

3. The handgrip pivot structure according to claim 1, wherein the mounting tube has an end that forms an expanded flange having an outside diameter greater than that of the pivot hole to prevent the mounting tube from separation from the pivot hole and wherein the shaft is arranged between and fixed to the mounting tubes by welding.

4. The handgrip pivot structure according to claim 1, wherein the shaft has opposite ends each forming an internally threaded bore, and wherein a bolt is set outside each arm and has a threaded section extending through the pivot hole of the arm to threadingly engage a respective internally threaded bore, the bolt having an expanded head abutting against an outside surface of the arm to prevent the shaft from separation from the pivot hole.

5. The handgrip pivot structure according to claim 1, wherein the shaft has a first end forming an expanded flange and an opposite second end forming an internally threaded bore, the shaft extending through the pivot hole of a first one of the arms with the flange abutting against the first arm, a bolt being provided outside a second one of the anus and having a threaded section extending through the pivot hole of the second arm to threadingly engage the internally threaded bore, the bolt having an expanded head abutting against an outside surface of the second arm.
